(19) United States
(12) Patent Application Publication
(10) Pub. No.: US 2025/0000090 A1
(43) Pub. Date: Jan. 2, 2025

(54) COMPOSITION

(71) Applicant: Syngenta Crop Protection AG, Basel (CH)

(72) Inventor: Manoj Varshney, Greensboro, NC (US)

(73) Assignee: Syngenta Crop Protection AG, Basel (CH)

(21) Appl. No.: 18/700,428

(22) PCT Filed: Oct. 10, 2022
(86) PCT No.: PCT/EP2022/078023

§ 371 Date: Apr. 11, 2024

(30) Foreign Application Priority Data
Oct. 15, 2021 (GB) 2114743.4

(51) Int. Cl. A01N 37/22; A01N 37/18; A01N 43/653; A01N 43/707; A01P 13/00

(52) U.S. Cl. CPC A01N 37/22; A01N 37/18; A01N 43/653; A01N 43/707; A01P 13/00

(57) ABSTRACT

A composition comprising S-metolachlor (S-MOC). sulfentrazone. metribuzin, and N. N-dimethyl lactamide. preferably wherein the composition is an Emulsion Concentrate (EC).

The present invention relates to compositions comprising a combination of crop protection compounds and non-aromatic solvent system, and the method of preparing and use of such a composition.

Emulsifiable concentrates are homogeneous liquid compositions dispersible in water or other liquid. In use, these concentrates are dispersed in water or other liquid and normally applied as a spray to the area to be treated. In the case of hydrophobic active compounds, these are typically combined with an appropriate liquid carrier, such as aromatic solvents.

Aromatic solvents are no longer desirable due to the presence of biphenyl, trimethylbenzene and cumene compounds, which are carcinogenic. These solvents are therefore likely to be phased out and/or subject to strict regulatory requirements.

There is therefore a need for a crop protection formulation that exhibits comparable or improved properties and performance, but that does not contain undesired aromatic solvent systems. This problem is particularly acute for active ingredients with poor solubility.

The present invention solves this problem through the provision of a composition comprising S-metolachlor (S-MOC), sulfentrazone, metribuzin, and N, N-dimethyl lactamide.

S-Metolachlor (S-MOC) and metolachlor are part of the chloroacetanilide family of herbicides, used to control grasses and broad-leafed weeds in maize. Sulfentrazone is a broad-spectrum herbicide and acts by inhibiting the enzyme protoporphyrinogen oxidase. Metribuzin is an herbicide used both pre-and post-emergence in crops and acts by inhibiting photosynthesis by disrupting photosystem II.

The structures of these components are shown in Table 1.

TABLE 1

| Compound | Structure |
|---|---|
| S-metolachlor | 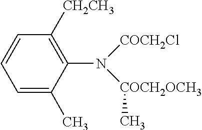 |
| Sulfentrazone | 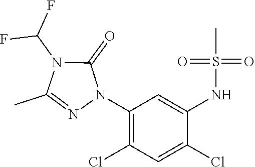 |
| metribuzin | 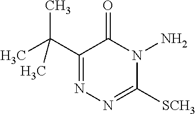 |
| N,N-dimethyl lactamide | 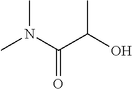 |

Preferably the composition is in the form of an emulsion concentrate (EC). ECs are one of the most common formulation types for crop protection products worldwide and when EC formulations are diluted with water in the spray tank, they form a spontaneous emulsion, where emulsion droplets are typically in the size range of 0.1 to 10.0 μm. The spontaneous emulsion can be optimised by selecting one or more compounds based upon their ability to emulsify the solvent system, including the active ingredient, into water. When sprayed, the dilute emulsion gives a uniform and accurate application of active ingredient on the crop, which is essential for effective pest control.

S-MOC, as a hydrophobic liquid, is advantageously used as a hydrophobic solvent to boost solubility of the metribuzin and sulfentrazone, which are typically solids under standard conditions. The combination of S-MOC and the non-aromatic solvent N, N-dimethyl lactamide results in a stable composition for all three active ingredients.

Indeed, the defined combination of components surprisingly forms a stable and processable composition with excellent emulsifiability in hard water and improved compatibility performance with tank mix partners.

An emulsion is a dispersion of one liquid in a second liquid continuous phase, where the two liquids concerned are essentially immiscible, or have limited mutual miscibility. To form an emulsion, the two immiscible phases are mixed while supplying sufficient energy to cause one phase to break up into droplets dispersed in the second phase. The energy input may take different forms such as stirring, ultrasound or repeated forced flow through narrow orifices. The basic factor in the stability or instability of an emulsion is the degree of interfacial tension (i.e., free energy) between the droplets of the dispersed liquid and the other continuous liquid phase.

Due to a less favourable interfacial tension, oil-in-water (EW) and water-in-oil (EO) emulsions are thermodynamically unstable and tend to coalesce over time leading to phase separation. To slow down coalescence of the emulsion droplets, the emulsion droplets can be stabilised by adding emulsifiers. Emulsifiers reduce the interfacial tension between the phases facilitating the formation of emulsion droplets. They also form a physical barrier, which prevents the emulsion droplets from coalescing.

Advantageously, the composition comprises one or more emulsifiers, preferably at least three emulsifiers, or even four or more emulsifiers.

Suitable emulsifiers are surfactants (anionic, cationic, or amphoteric, and nonionic surfactants).

Suitable ionic surfactants are the alkali, alkaline earth and ammonium salts of aromatic sulphonic acids, for example of lignosulphonic acid, phenolsulphonic acid, naphthalenesulphonic acid, dibutylnaphthalenesulphonic acid or of fatty acids, alkyl-and alkylarylsulfonates, alkylsulphates, lauryl ether sulphates and fatty alcohol sulphates, and salts of sulphated hexa-, hepta-and octa-decanols, and of fatty alcohol glycol ethers, condensates of sulfonated naphthalene and its derivatives with formaldehyde, condensates of naphthalene or of the naphthalenesulphonic acids with phenol and formaldehyde, polycarboxylates or phosphate esters of alkoxylated alcohols.

Suitable nonionic surfactants are polyoxyethylene octyl phenol ethers, alkoxylated alcohols such as ethoxylated isooctyl-, octyl-or nonyl-phenol, alkylphenyl polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin- sulfite waste liquors and also proteins, denatured proteins, polysaccharides (for example methylcellulose), hydrophobically modified starches, polyvinyl alcohols (for example Mowiol®), polyalkoxylates, polyvinylamines, polyethyleneimines, polyvinylpyrrolidones and their copolymers or block polymers.

Preferably the emulsifiers comprise ethoxylated alcohols, alkylbenzene sulphonic acids and/or sorbitan derivatives.

Most preferred is when the emulsifiers are selected from condensation products of castor oil and ethylene-oxide, Ca-salts of dodecyl-benzene sulfonic acid, copolymers of butanol and propoxylated/ethoxylate, polyoxyethylene sorbitan trioleate, and/or ethoxylated alcohols.

The total quantity of emulsifier is preferably from 5 to 25% by weight, from 6 to 20% by weight, from 7 to 18% by weight, from 8 to 17% by weight, or even from 10 to 15% by weight.

Preferably the N, N-dimethyl lactamide is present in an amount from 1 to 50% by weight, such as from 5 to 25% by weight, from 6 to 20% by weight, from 7 to 18% by weight, from 8 to 17% by weight, or even from 10 to 15% by weight.

The composition may optionally contain a second non-aromatic solvent in addition to N, N- dimethyl lactamide, such as 2-ethylhexyl-5-lactate. This solvent may be present in an amount from 5 to 15% by weight.

Advantageously, the composition contains no, or substantially no, aromatic solvents. By ‘substantially no’ we mean less than 0.5% by weight.

By ‘aromatic solvents’, we meant solvents which contain one or more phenyl rings.

Preferably the S-metolachlor is present in an amount of from 40 to 70% by weight, such as from 45 to 68% by weight, from 49 to 65% by weight, from 50 to 60% by weight, or even from 51 to 59% by weight.

Preferably the sulfentrazone is present in amount of from 1 to 15% by weight, such as from 2 to 13% by weigh, from 3 to 10% by weight, or even from 4 to 8% by weight.

Preferably the metribuzin is present in amount of from 5 to 20% by weight, such as from 6 to 18% by weight, from 7 to 15% by weight, or even from 8 to 12% by weight.

The ratio of N, N-dimethyl lactamide to the one of more emulsifiers is preferably from 3:1 to 1:3, such as from 2:1 to 1:2, or even 1.3:1 to 1:1.3.

Advantageously, the composition may comprise an antifoaming agent. The compositions of the present invention may include other ingredients such as a viscosity modifier, an anti-bacterial agent, adjuvants, a colourant, or a perfume.

The present invention also relates to compositions produced in a farmer's spray tank of water when a concentrate is mixed with water in the spray tank. A composition of the present invention may be in the form of a ready-mix emulsion formulation, packaged within a single vessel and ready to use directly after dilution.

The composition may be combined with at least one further active ingredient, typically a crop protection active ingredient. This further active ingredient may be in any form, such as EC, SE (suspo-emulsion concentrate) or an SL (soluble liquid).

The compositions of the present invention may relate to concentrates designed to be added to a farmer's spray tank of water or they may be applied directly without further dilution, preferably designed to be added to a farmer's spray tank of water. Thus, in a second aspect of the invention there is provided a method of mixing a composition as described herein with water in a tank so as to form an emulsion. Optionally, the water is hard water.

By ‘hard water’ we mean water with greater than 120 ppm of CaCO₃ and/or MgCO₃.

In a third aspect of the invention there is provided a method of controlling weeds at a locus comprising application to the locus of a weed controlling amount of a composition as described herein.

In a fourth aspect of the invention there is provided the use of a composition as described herein as a herbicide.

In a fifth aspect there is provided the use of a composition as defined herein to form an emulsion in hard water, preferably where the emulsion is stable.

Unless otherwise stated are percentages are given as percentages by total weight and all embodiments and preferred features may be combined in any combination.

The invention is described by the following non-limiting Examples.

### EXAMPLES

The following compositions were prepared, with Compositions 1 to 3 being compositions according to the invention.

TABLE 2

| Composition 1 | % wt |
|---|---|
| S-metolachlor | 57.6 |
| Metribuzin | 10.2 |
| Sulfentrazone | 5.76 |
| Non-aromatic Solvent (2-ethylhexyl-5-lactate) | 7.5 |
| Emulsifier 1 | 3.5 |
| Emulsifier 2 | 2.25 |
| Emulsifier 3 | 0.8 |
| Antifoam | 0.04 |
| N,N-dimethyl lactamide | Up to 100% |

TABLE 3

| Composition 2 | % wt |
|---|---|
| S-metolachlor | 57.6 |
| Metribuzin | 10.2 |
| Sulfentrazone | 5.76 |
| Non-aromatic Solvent (2-ethylhexyl-5-lactate) | 7.5 |
| Emulsifier 2 | 6.4 |
| Emulsifier 3 | 4.6 |
| Emulsifier 4 | 1 |
| Emulsifier 5 | 1.25 |
| Antifoam | 0.04 |
| N,N-dimethyl lactamide | Up to 100% |

TABLE 4

| Composition 3 | % wt |
|---|---|
| S-metolachlor | 57.6 |
| Sulfentrazone | 5.76 |
| Metribuzin | 10.2 |
| Emulsifier 4 | 2.3% |
| Emulsifier 2 | 4% |
| Emulsifier 3 | 4.25% |
| Emulsifier 5 | 3.0% |
| Antifoam | 0.04% |
| N,N-dimethyl lactamide | up to 100% |

TABLE 5

| Composition 4 [comparative] | % wt |
|---|---|
| S-metolachlor | 68.3 |
| Sulfentrazone | 7.5 |
| Mixture of Octanoic acid-decanoic acid- | 18.6 |
| N,N-dimethylamide | |
| Emulsifier 9 | 9.6 |
| Emulsifier 3 | 2.4 |
| Antifoam | 0.04 |
| Mixture of Aromatic solvent | Up to 100% |

TABLE 6

| Composition 5 [comparative] | % wt |
|---|---|
| S-metolachlor | 58.2 |
| Metribuzin | 13.6 |
| Emulsifier 6 | 4.3 |
| Emulsifier 7 | 1.0 |
| Emulsifier 8 | 5.0 |
| Antifoam | 0.04 |
| Mixture of Aromatic solvent | Up to 100% |

TABLE 7

| Emulsifier | Structure |
|---|---|
| Emulsifier 1 | Condensation product of castor oil and ethylene-oxide |
| Emulsifier 2 | Dodecyl-benzene sulphonic acid Ca-salt linear |
| Emulsifier 3 | Copolymer modified PO/EO |
| Emulsifier 4 | Polyoxyethylene sorbitan trioleate |
| Emulsifier 5 | Ethoxylated alcohol |
| Emulsifier 6 | Polyalkoxylated alkylphenol |
| Emulsifier 7 | Polyoxyalkylated nonylphenol phosphate ester |
| Emulsifier 8 | Neutralized nonylphenol ether sulphate |
| Emulsifier 9 | Blend of calcium sulphonate and nonionic surfactant |

### Emulsion Test

The compositions listed above were tested for their emulsibility in extremely hard water (500 ppm CaCO₃/MgCO₃).

Each of the compositions at a concentration of from 2 to 4% v/v were mixed with 100 ml of hard water to form an emulsion and measured visually on a 1 to 4 scoring system, with 4 being the best, after standing for the stated length of time. A score of 4 indicates no significant sedimentation, separation, or creaming. The results are set out in Table 8.

TABLE 8

| | 4 weeks | 4 weeks |
|---|---|---|
| | (−10° C.) | (50° C.) |
| Composition 1 | 3 | 2 |
| Composition 2 | 3 | 2 |
| Composition 3 | 4 | 4 |
| Composition 4 | 3 | 3 |
| Composition 5 | 3 | 3 |
| Composition 6 | 4 | 3 |

The compositions of the invention show comparable or improved emulsibility in hard water compared to the comparative compositions 4, 5 and 6, with composition 3 being particularly good in hard water.

### Tank Mix Compatibility

Composition 3 was tested with a wide range of commercially available tank mixing partners to test compatibility in both hard and soft water. Compatibility is assessed on the scale shown in Table 9 and the results are set out in Table 10.

TABLE 9

| Key | Rating Description |
|---|---|
| C | Compatible |
| CA | Compatible with agitation |
| CA-1 | Marginally compatible with agitation-sediment |
| CA-2 | Marginally compatible with agitation-tank clean up |
| I | Incompatible |

TABLE 10

| Mix Partners | | | | |
|---|---|---|---|---|
| (Commercial names and | | | | Dynamic |
| trade marks ™) | All Use Rates | Carrier | | Rating |
| AIM EC HERBICIDE | 35 fl oz/A + 1 fl oz/A | 50 | ppm Water | C |
| AIM EC HERBICIDE | 35 fl oz/A + 1 fl oz/A | 500 | ppm Water | C |
| DUAL MAGNUM HERBICIDE | 35 fl oz/A + 1 pt/A | 50 | ppm Water | C |
| DUAL MAGNUM HERBICIDE | 35 fl oz/A + 1 pt/A | 500 | ppm Water | C |
| ENLIST DUO | 35 fl oz/A + 64 fl oz/A | 50 | ppm Water | C |
| ENLIST DUO | 35 fl oz/A + 64 fl oz/A | 500 | ppm Water | C |
| ENLIST ONE HERBICIDE | 35 fl oz/A + 32 fl oz/A | 50 | ppm Water | C |
| ENLIST ONE HERBICIDE | 35 fl oz/A + 32 fl oz/A | 500 | ppm Water | C |
| FUSILADE DX | 35 fl oz/A + 16 fl oz/A | 50 | ppm Water | C |
| FUSILADE DX | 35 fl oz/A + 16 fl oz/A | 500 | ppm Water | C |
| FUSION | 35 fl oz/A + 8 fl oz/A | 50 | ppm Water | C |
| FUSION | 35 fl oz/A + 8 fl oz/A | 500 | ppm Water | C |
| Gramoxone SL 3.0 | 35 fl oz/A + 32 fl oz/A + | 50 | ppm Water | C |
| (A12837AM) + ACTIVATOR 90 | 0.5% v/V | | | |
| Gramoxone SL 3.0 | 35 fl oz/A + 32 fl oz/A + | 500 | ppm Water | C |
| (A12837AM) + ACTIVATOR 90 | 0.5% v/V | | | |
| LIBERTY 280 SL | 35 fl oz/A + 32 fl oz/A | 50 | ppm Water | C |
| LIBERTY 280 SL | 35 fl oz/A + 32 fl oz/A | 500 | ppm Water | C |
| PURSUIT | 35 fl oz/A + 4 fl oz/A | 50 | ppm Water | C |
| PURSUIT | 35 fl oz/A + 4 fl oz/A | 500 | ppm Water | C |
| REFLEX | 35 fl oz/A + 16 fl oz/A | 50 | ppm Water | C |
| REFLEX | 35 fl oz/A + 16 fl oz/A | 500 | ppm Water | C |
| ROUNDUP POWERMAX | 35 fl oz/A + 32 fl oz/A | 50 | ppm Water | C |
| ROUNDUP POWERMAX | 35 fl oz/A + 32 fl oz/A | 500 | ppm Water | C |
| SELECT MAX | 35 fl oz/A + 12 fl oz/A | 50 | ppm Water | C |
| SELECT MAX | 35 fl oz/A + 12 fl oz/A | 500 | ppm Water | C |
| SHARPEN | 1 fl oz/A + 35 fl oz/A | 50 | ppm Water | C |
| SHARPEN | 1 fl oz/A + 35 fl oz/A | 500 | ppm Water | C |
| SPARTAN 4F | 8 fl oz/A + 35 fl oz/A | 50 | ppm Water | C |
| SPARTAN 4F | 8 fl oz/A + 35 fl oz/A | 500 | ppm Water | C |
| Dimetric Liquid | 6 fl oz/A + 35 fl oz/A | 50 | ppm Water | C |
| Dimetric Liquid | 6 fl oz/A + 35 fl oz/A | 500 | ppm Water | C |
| XTENDIMAX | 35 fl oz/A + 22 fl oz/A | 50 | ppm Water | C |
| XTENDIMAX | 35 fl oz/A + 22 fl oz/A | 500 | ppm Water | C |

The composition accordingly to the invention can be seen to have superlative mixing properties with an extraordinarily large range of partners.

### Tank Mix Compatibility—Composition 3 vs Composition 4

Dynamic testing involves mixing and subsequently testing the relevant property, while the static test involved leaving the mixed composition for 24 hours prior to the test.

Composition 3 was also compared directly with comparative Composition 4 in a static test after 24 hours, with the results set out in Table 11.

TABLE 11

| | | | Static Rating | |
|---|---|---|---|---|
| Mix Partners | Use Rates | Carrier | Composition 3 | Composition 4 |
| ENLIST DUO | 35 fl oz/A + | 500 ppm Water | CA | CA-1 |
| | 64 fl oz/A | | | |
| FUSION | 35 fl oz/A + | 500 ppm Water | CA | CA-1 |
| | 8 fl oz/A | | | |
| SELECT MAX | 35 fl oz/A + | 500 ppm Water | CA | CA-1 |
| | 12 fl oz/A | | | |

### Spray Test

Composition 3 was also tested in the application lab for a wide range physical properties and performance during spraying. The results are set out in Table 12.

TABLE 12

| | Use Rates | | | |
|---|---|---|---|---|
| | 1.2 pt/A (pint/acre) | | 2.8 pt/A | |
| | Dynamic | 24 hrs Static | Dynamic | 24 hrs Static |
| Foaming | No Issue | No Issue | No Issue | No Issue |
| Flocculation | No Issue | No Issue | No Issue | No Issue |
| Sedimentation | No Issue | No Issue | No Issue | No Issue |
| Spray out | No Issue | No Issue | No Issue | No Issue |
| In-line filter and filter housing | Clean | Clean | Clean | Clean |
| Spray Nozzle and Screen | Clean | Clean | Clean | Clean |
| Tank Cleanout | No Issue | No Issue | No Issue | No Issue |

Most commercial compositions leave sediment and leave the equipment in need of significant cleaning. However, as shown above, compositions according to the present invention demonstrated none of these downsides and instead demonstrated remarkable stability and physical properties. Microscopy tests confirmed that there were no residues or crystals in the tank after rinsing with water.

The invention is defined by the claims.

1. A composition comprising S-metolachlor (S-MOC), sulfentrazone, metribuzin, and N, N-dimethyl lactamide, preferably wherein the composition is an Emulsion Concentrate (EC).

2. The composition according to claim 1 comprising one or more emulsifiers.

3. The composition according to claim 2, wherein the one or more emulsifiers comprise at least one, at least two or at least three, ethoxylated alcohols, alkylbenzene sulphonic acids and/or sorbitan derivatives.

4. The composition according to claim 1, wherein the N, N-dimethyl lactamide is present in an amount from 1 to 50% by weight, preferably from 5 to 25% by weight.

5. The composition according to claim 1, wherein the S-metolachlor is present in an amount of from 40 to 70% by weight.

6. The composition according to claim 1, wherein the Sulfentrazone is present in amount of from 1 to 15% by weight.

7. The composition according to claim 1, wherein the metribuzin is present in amount of from 5 to 20% by weight.

8. The composition according to claim 1, wherein the ratio of N, N-dimethyl lactamide to the one of more emulsifiers is from 3:1 to 1:3.

9. The composition according to claim 1, further comprising an antifoaming agent.

10. The composition according to claim 1, further comprising at least one active ingredient.

11. The composition according to claim 1, wherein the composition contains substantially no aromatic solvents.

12. A method of mixing a composition according to claim 1 with water in a tank so as to form an emulsion.

13. A method of controlling weeds at a locus comprising application to the locus of a weed controlling amount of a composition according to any one of claim 1.

14. (canceled).

15. (canceled).
